(19) United States
(12) Patent Application Publication
(10) Pub. No.: US 2018/0361858 A1
(43) Pub. Date: Dec. 20, 2018

(54) ENERGY STORAGE ARRANGEMENT

(71) Applicant: Mahle International GmbH, Stuttgart (DE)

(72) Inventors: Stefan Hirsch, Stuttgart (DE); Thomas Kalmbach, Stuttgart (DE); Jessica Kansy, Stuttgart (DE); Heiko Neff, Auenwald (DE); Mario Wallisch, Aichtal (DE); Achim Wiebelt, Neustadt (DE)

(21) Appl. No.: 15/976,379

(22) Filed: May 10, 2018

(30) Foreign Application Priority Data
May 11, 2017 (DE) 102017207966.5

(51) Int. Cl. B60L 11/18

(52) U.S. Cl. CPC B60L 11/187; B60L 2240/36

(57) ABSTRACT

The invention relates to an energy storage arrangement (1) having at least one energy store (2) and having a temperature-control device (3) for cooling/heating the at least one energy store (2),
wherein the at least one energy store (2) has two electrical cell conductors (4),
wherein the temperature-control device (3) has a spray compartment (5) in which at least one energy store (2) is received with its cell conductors (4),
wherein a fluid distributing system (6) is provided, via which at least the cell conductors (4) can be sprayed with dielectric temperature-control fluid (7).

### CROSS-REFERENCE TO RELATED APPLICATIONS

This application claims priority to German Patent Application No. 10 2017 207 966.5, filed on May 11, 2017, the contents of which are hereby incorporated by reference in its entirety.

### TECHNICAL FIELD

The present invention relates to an energy storage arrangement having at least one energy store and a temperature-control device for cooling/heating the energy store. The invention moreover relates to a motor vehicle having at least one such energy storage device.

### BACKGROUND

Owing to a growth in electromobility, constantly increasing requirements are also placed on the range and therefore the power of electrical energy stores. To enable an increase in power, electrical energy stores today are therefore already temperature-controlled, i.e. cooled or heated, and therefore kept within a temperature window which is optimal in terms of power output. In this case, to cool the energy store, a separate heat exchanger in the form of one or more plates through which fluid can flow has hitherto been used regardless of the respective cell type. Depending on requirements and the necessary cooling power, this can be combined with additional components of a thermally conductive material to increase the heat-exchanging surface and therefore, in turn, also the cooling power.

To furthermore enable the installation space in modern motor vehicles, in particular in electric vehicles, to be used as optimally as possible, there has also been an increase in the use of so-called pouch cells, which, in contrast to the hitherto widely used cylindrical cells with a generally solid metal outer shell and active layers wound around an inner electrode, now have stacked or folded active layers which are enclosed by a flexible outer film, generally aluminium-based. In this case, the open outer sides of the outer film/outer bag are generally thermally welded. A plurality of electrical energy stores or individual cells can be stacked in the interior of the outer bag so that it is possible to increase the electrical voltage in a series circuit and the capacitance and current rating in a parallel circuit. Particular advantages of such pouch cells are comparatively small thicknesses owing to the lack of an outer housing, a low weight and, above all, flexibly configurable dimensions. However, depending on the design of the surface, such pouch cells are often not very efficiently coolable compared to the hard case cells hitherto known from the prior art. From a thermal point of view here, the connection to the electrical cell conductors at the same time also provides the best heat dissipation for the waste heat from a cell core of the electrical energy store. However, owing to the relatively high voltages along with the necessary protection against short circuit and arcing, this manner of cooling with a conventional heat exchanger is only possible with difficulty, if at all.

### SUMMARY

The present invention is therefore concerned with the problem of providing an energy store which is in particular optimized in terms of installation space and at the same time enables improved cell temperature control in the case of particularly high charge and discharge rates and the large amounts of waste heat associated therewith.

This problem is solved according to the invention by the subject matter of the independent claim(s). Advantageous embodiments are the subject matter of the dependent claim(s).

The present invention is based on the general idea of, for the first time, using a spray temperature control, in particular a spray cooling, for electrical energy stores, whereby effective temperature control, in particular effective cooling, of the electrical energy stores is enabled. This is particularly highly advantageous if the electrical energy stores are designed as so-called pouch cells or pouch bags. In this case, the energy storage arrangement according to the invention has at least one energy store and a temperature-control device for cooling/heating the energy store. The temperature-control device comprises a spray compartment in which at least one energy store is received with its cell conductors. A fluid distributing system (e.g. common rail) is likewise provided, via which the cell conductors can be sprayed with a dielectric, i.e. electrically poorly conductive, preferably virtually non-conductive, temperature-control fluid. By spraying the cell conductors as required, it is also particularly possible for an efficient and highly effective cooling or heating of the cell core to take place, which, particularly in the case of energy stores designed as pouch cells, would otherwise not be possible via their surface. In this case, it goes without saying that the fluid distributing system (e.g. common rail) can be arranged such that it applies temperature-control fluid, in particular cooling fluid, solely, i.e. exclusively, to the cell conductors and/or also to a busbar, a cell module connector or the like, which are likewise connected to the individual energy stores with good thermal conductivity. In this case, the temperature-control device according to the invention is conventionally used for cooling the electrical energy stores, although it can purely theoretically also be used to heat this latter, in particular during a cold start phase. The temperature-control device according to the invention is moreover highly advantageous in that, compared to cooling tubes or cooling plates for example, it enables greater tolerance compensation owing to a particularly variable jet or spray length up to the point of impact on the surface to be temperature-controlled, for example the cell conductor. Moreover, it requires less installation space and has a reduced weight, which is particularly highly advantageous when used in motor vehicles, for example in electric vehicles. Temperature-control fluid is not sprayed on the cell conductors in the non-activated state, which means that creepage currents are not present. With the previously used cooling tubes or cooling plates, such creepage currents were always present, at least to a slight extent, and resulted in a capacitance loss, at least in the long term, when the vehicle was stationary.

In an advantageous further development of the solution according to the invention, the fluid distributing system (e.g. common rail) is arranged in the spray compartment, above the cell conductors to be temperature-controlled. In this case, it goes without saying that, if desired, the fluid distributing system (e.g. common rail) is also arranged above the busbar, cell and module connectors so that it is also possible to apply temperature-control fluid, for example cooling fluid, thereto. Owing to the arrangement of the fluid distributing system (e.g. common rail) above the components to be cooled, i.e. cell conductors, busbar and module connectors, it is still possible to achieve a discernable temperature control as a result of gravity alone, even in the event of a drop in pressure. It can alternatively also be provided that the fluid distributing system, a spray nozzle and the collecting channel are arranged below the cell conductors or the energy store. It is also conceivable that the fluid distributing system is arranged above the cell conductors or above the energy store and sprays these, preferably completely, from above. In this case, wall cooling of the energy store would therefore also be possible, for example.

A collecting channel for collecting and conducting the temperature-control fluid is arranged in the spray compartment, below the cell conductors to be temperature-controlled. Via this collecting channel, the temperature-control fluid, which is heated for example by the cell conductors, is received and supplied to a temperature-control fluid reservoir or a pump via a corresponding fluid line. The temperature-control fluid line, the fluid distributing system (e.g. common rail), the temperature-control fluid reservoir and the collecting channel therefore form a temperature-control fluid circuit.

In an advantageous further development of the solution according to the invention, the spray compartment has at least two mutually separate segments which can all have temperature-control fluid applied to them by the fluid distributing system (e.g. common rail). Purely theoretically, it is thus conceivable to control the temperature of individual energy stores individually, that is to say in particular to cool them individually, whereby a particularly needs-based cooling can be achieved. To this end, for example, temperature sensors can also be arranged on or in the individual electrical energy stores and be connected to a detecting device which then enables individual cooling or temperature control of the energy stores which need it. To this end, controllable nozzles can be provided in the fluid distributing system (e.g. common rail) which are opened and closed as required and thus enable the individual cooling of individual energy stores.

The (fluid) collecting channel is expediently communicatively connected to at least two segments. It goes without saying that the collecting channel is conventionally connected to all segments, whereby only a single collecting channel for receiving all the fluid from all of the segments is required.

In a further advantageous embodiment of the solution according to the invention, a separating wall separating two adjacent segments from one another also separates two adjacent energy stores from one another. Such a separating wall is therefore arranged between the respective outer surfaces of two adjacent energy stores and projects beyond these as a separating wall into the spray compartment. In this case, it is conceivable that the fluid distributing system (e.g. common rail) is designed and aligned such that the temperature-control fluid which is sprayed thereby also strikes the wall/separating wall, which in this case is preferably designed to be highly thermally conductive and, owing to its extent outside the spray compartment between the two adjacent energy stores, also enables cooling or heating, i.e. temperature control, of the outer surfaces of the adjacent energy stores.

The present invention is further based on the general idea of equipping a motor vehicle, in particular an electric vehicle or a hybrid vehicle, with such an energy storage arrangement according to the invention and thus considerably increasing its power or range.

Further important features and advantages of the invention are revealed in the subclaims, in the drawings and in the associated description of the figures with reference to the drawings.

It goes without saying that the features which are mentioned above and are still to be explained below can be applied not only in the combinations specified in each case, but also in other combinations or in isolation without deviating from the scope of the present invention.

Preferred exemplary embodiments of the invention are illustrated in the drawings and will be explained in more detail in the description below, wherein identical reference signs relate to identical or similar or functionally identical components.

### BRIEF DESCRIPTION OF THE DRAWINGS

The drawings thereby show, in each case schematically:

FIG. 1 an energy storage arrangement according to the invention in the region of the temperature-control device in a first embodiment;

FIG. 2 an illustration as shown in FIG. 1, but for a second embodiment.

### DETAILED DESCRIPTION

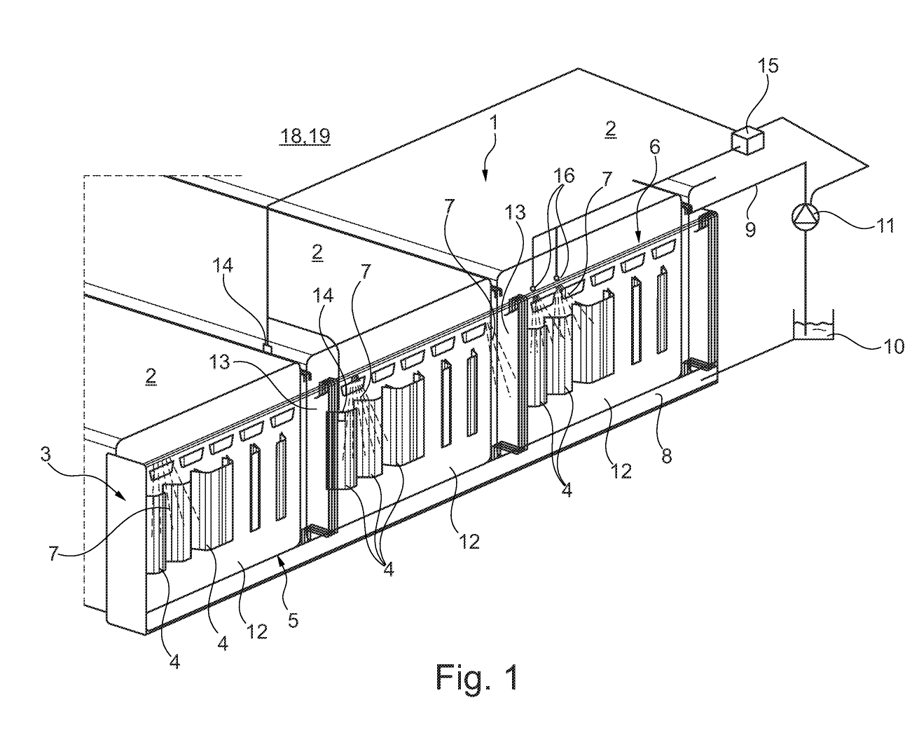

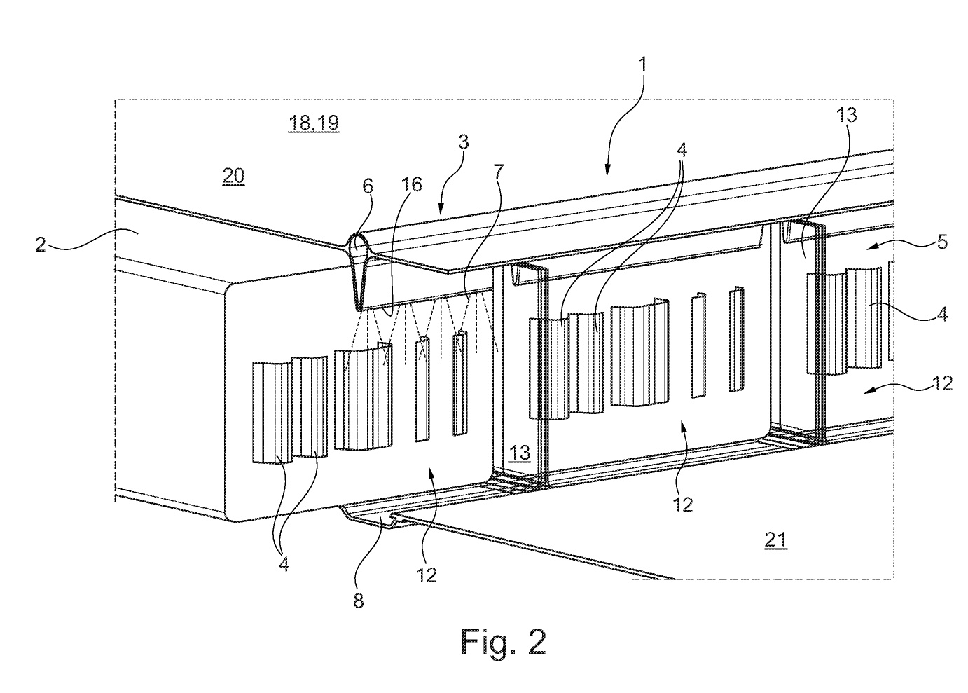

According to FIGS. 1 and 2, an energy storage arrangement 1 according to the invention has at least one energy store 2, here a plurality of energy stores 2, which are arranged parallel to one another in the present case. In particular, the energy stores 2 in this case can be designed as so-called pouch cells or pouch bags, whereby, in particular, increased flexibility and also the use of previously unusable spaces are possible. Furthermore, the energy storage arrangement 1 according to the invention has a temperature-control device 3 for cooling/heating the energy store 2, in particular for cooling this latter. Each of the energy stores 2 has at least two electrical cell conductors 4, via which an electrical connection to an electrical consumer, for example, is produced. The temperature-control device 3 moreover has a spray compartment 5 in which at least one of the energy stores 2 is received with its cell conductors 4. The entire battery system can also serves as a spray compartment so that temperature-control fluid can be applied to all internal components of the energy store which are to be temperature-controlled. A fluid distributing system (e.g. common rail) 6 is moreover provided, via which the cell conductors 4 can be sprayed with dielectric temperature-control fluid 7, for example cooling fluid. In this case, the temperature-control fluid 7 is illustrated by a broken line according to FIGS. 1 and 2.

As can be seen, the fluid distributing system (e.g. common rail) 6 is arranged in the spray compartment 5, above the cell conductors 4, whereby gravity-assisted spraying of the cell conductors 4 can take place. A collecting channel 8 for collecting the temperature-control fluid 7 is arranged below the cell conductors 4 which are to be temperature-controlled. In this case, the collecting channel 8 and the fluid distributing system (e.g. common rail) 6 are communicatively connected via a temperature-control fluid line 9, wherein a temperature-control fluid reservoir 10 and a pump 11 are moreover arranged in the temperature-control fluid line 9 (c.f. FIG. 1).

It goes without saying that the fluid distributing system (e.g. common rail) 6 can also be designed such that it can apply temperature-control fluid 7 not only to the cell conductors 4 but to a busbar and cell and module connectors, for example, which are likewise connected to the electrical energy stores 2 with good thermal conductivity.

It can be seen from further observation of FIGS. 1 and 2 that the spray compartment 5 has at least two mutually separate segments 12 or portions 12 which can all have temperature-control fluid 7 applied to them by the fluid distributing system (e.g. common rail) 6. In this case, the collecting channel 8 is communicatively connected to all segments 12. In this case, a respective separating wall 13 separating two adjacent segments 12 is arranged between these segments and not only divides the spray compartment 5 into different segments 12 but preferably also extends further outside the spray compartment 5 between two adjacent energy stores 2. It is therefore also conceivable in the present case that the fluid distributing system (e.g. common rail) 6 is designed or aligned such that it can spray or apply temperature-control fluid 7 to the separating wall 13, whereby this is cooled or heated and the cooling or heating effect is also transmitted to an outer wall of the respectively adjacent energy stores 2. To this end, the separating wall 13 is preferably made from a material with good thermal conductivity. By means of such separating walls 13, the spray cooling of the cell conductors 4 at the same time also enables a spray cooling of the outer surfaces of the energy stores 2, whereby the cooling power or optionally also the heating power can be increased.

The fluid distributing system (e.g. common rail) 6 is designed as an upwardly open trough according to FIG. 1, wherein it is self-evidently clear that the fluid distributing system (e.g. common rail) 6 is closed with the exception of the openings directed into the spray compartment 5, whereby a build up of pressure is enabled, as illustrated in FIG. 2.

According to FIG. 2, it can be seen that the fluid distributing system (e.g. common rail) 6 is a component of an energy store cover 20 and the collecting channel 8 is component of an energy store base 21. This refers in particular to an integral component, which makes for more economical manufacture.

In a specific embodiment (only illustrated in FIG. 1), temperature sensors 14 can moreover be provided, which enable individual temperature detection at a cell conductor 4, for example, or in the region of an energy store 2 and transmit the temperature data detected thereby to a control device 15. If the fluid distributing system (e.g. common rail) 6 moreover has individually controllable spray nozzles 16 (c.f. also FIG. 2), it is conceivable that a particularly needs-based cooling of individual cell conductors 4 of individual energy stores 2 is enabled as required. It goes without saying that the control device 15 can also be communicatively connected to the pump 11.

The energy storage arrangement 1 can be used in a motor vehicle, for example in an electric vehicle 18 or a hybrid vehicle 19, whereby the power and range thereof can be increased. By means of the energy storage arrangement according to the invention and the temperature-control device 3 used for cooling or controlling the temperature in general of said energy storage arrangement, it is possible to provide economical and moreover extremely flexible temperature control of the energy store 2 in a manner which is optimised in terms of weight and installation space, wherein, in particular, temperature-control fluid 7 does not reach the cell conductors 4 at all when the temperature-control device 3 is switched off and creepage currents can thus be eliminated.

1. An energy storage arrangement comprising:
at least one energy store; and
a temperature-control device for at least one of cooling and heating the at least one energy store;
wherein the at least one energy store includes two electrical cell conductors;
wherein the temperature-control device includes a spray compartment in which the at least one energy store and the two cell conductors are arranged; and
wherein a fluid distributing system is configured to spray at least the two cell conductors with a dielectric temperature-control fluid.

2. The energy storage arrangement according to claim 1, wherein the fluid distributing system is arranged in the spray compartment above the two cell conductors.

3. The energy storage arrangement according to claim 1, further comprising a collecting channel for collecting the temperature-control fluid arranged in the spray compartment below the two cell conductors.

4. The energy storage arrangement according to claim 3, wherein the collecting channel and the fluid distributing system are communicatively connected to one another via a temperature-control fluid line.

5. The energy storage arrangement according to claim 4, further comprising at least one of a temperature-control fluid reservoir and a pump arranged in the temperature-control fluid line.

6. The energy storage arrangement according to claim 1, wherein the spray compartment has at least two mutually separate segments, and wherein the fluid distributing system can apply the temperature-control fluid to the at least two segments.

7. The energy storage arrangement according to claim 6, further comprising a collecting channel for collecting the temperature-control fluid arranged in the spray compartment below the two cell conductors, the collecting channel communicatively connected to the at least two segments.

8. The energy storage arrangement according to claim 6, wherein the at least one energy store includes at least two energy stores arranged adjacent to one another, and wherein a separating wall separates the at least two segments from one another and also separates the at least two adjacent energy stores from one another.

9. The energy storage arrangement according to claim 8, wherein the fluid distributing system is configured to apply the temperature-control fluid to the separating wall.

10. The energy storage arrangement according to claim 1, further comprising a control device, at least one temperature sensor, and a controllable spray nozzle communicatively connected to one another.

11. The energy storage arrangement according to claim 1, wherein one of:
the fluid distributing system, a spray nozzle of the fluid distributing system, and a collecting channel for collecting the temperature-control fluid are arranged below at least one of i) the two cell conductors and ii) the at least one energy store; and
the fluid distributing system is arranged above at least one of i) the two cell conductors and ii) the at least one energy store and sprays the at least one of i) the two cell conductors and ii) the at least one energy store from above.

12. The energy storage arrangement according to claim 1, further comprising at least one of:
an energy store cover including the fluid distributing system; and
an energy store base including a collecting channel for collecting the temperature-control fluid.

13. A motor vehicle comprising an energy storage arrangement including:
at least one energy store including two electrical cell conductors;
a temperature-control device for at least one of cooling and heating the at least one energy store, the temperature-control device including a spray compartment in which the at least one energy store and the two cell conductors are arranged; and
a fluid distributing system configured to spray at least the two cell conductors with a dielectric temperature-control fluid.

14. The energy storage arrangement according to claim 1, wherein the fluid distributing system is a common rail.

15. The energy storage arrangement according to claim 11, wherein the fluid distributing system completely sprays the at least one of i) the two cell conductors and ii) the at least one energy store.

16. The energy storage arrangement according to claim 1, further comprising:
an energy store cover including the fluid distributing system; and
an energy store base including a collecting channel for collecting the temperature-control fluid.

17. The motor vehicle according to claim 13, further comprising a collecting channel for collecting the temperature-control fluid arranged in the spray compartment below the two cell conductors.

18. The motor vehicle according to claim 17, wherein the collecting channel and the fluid distributing system are communicatively connected to one another via a temperature-control fluid line.

19. An energy storage arrangement comprising:
a plurality of energy stores each including at least two electrical cell conductors;
a temperature-control device for at least one of cooling and heating the plurality of energy stores, the temperature-control device including a spray compartment in which at least one energy store of the plurality of energy stores is arranged;
a separating wall arranged within the spray compartment and dividing the spray compartment into two adjacent segments; and
a fluid distributing system configured to spray at least the at least two cell conductors of an energy store of the plurality of energy stores with a dielectric temperature-control fluid.

20. The energy storage arrangement according to claim 19, wherein the separating wall extends outside the spray compartment and between two adjacent energy stores of the plurality of energy stores.
